(19) United States
(12) Patent Application Publication
(10) Pub. No.: US 2018/0230328 A1
(43) Pub. Date: Aug. 16, 2018

(54) STRADDLE VEHICLE AND EXTERNAL MEMBERS THEREOF

(71) Applicant: KAWASAKI JUKOGYO KABUSHIKI KAISHA, Kobe-shi (JP)

(72) Inventors: Fumihiro Nakagawa, Kakogawa-shi (JP); Takahiro Osaki, Kobe-shi (JP); Yuuki Takahashi, Kakogawa-shi (JP)

(21) Appl. No.: 15/950,075

(22) Filed: Apr. 10, 2018

Related U.S. Application Data
(63) Continuation-in-part of application No. 15/163,568, filed on May 24, 2016.

(30) Foreign Application Priority Data
Nov. 24, 2017 (JP) 2017-226352

(51) Int. Cl. C09D 175/04; B62J 17/00; B62J 35/00; C09D 5/00; C09D 5/32; C09D 1/00

(52) U.S. Cl. CPC C09D 175/04; B62J 17/00; C09D 1/00; C09D 5/006; C09D 5/32; B62J 35/00

(57) ABSTRACT

A straddle vehicle comprises a first external member having an outer surface exposed to outside of the straddle vehicle, the first external member includes a base section and a coating section coated on the base section, the coating section includes a color layer, and a light transmission layer stacked on the color layer and having the outer surface exposed to outside of the straddle vehicle, and the light transmission layer includes a self-restoring resin.

### BACKGROUND OF THE INVENTION

### Field of the Invention

The present invention relates to a straddle vehicle such as a motorcycle, and an external member thereof.

### Description of Related Art

In an exemplary motorcycle disclosed in Japanese Laid-Open Patent Application Publication No. Hei. 5-76820, for example, external members mounted to its vehicle body, such as a fuel tank and cowlings, are coated to improve their external appearances.

In a straddle vehicle such as the motorcycle, a rider may sometimes contact (rub) the external member and thereby a scratch (flaw) may be formed on a coated surface thereof. In the course of manufacturing steps of the straddle vehicle, the external member having the scratch formed on the coated surface thereof is determined as a defective product in an external appearance test step, and sent to a scratch repair step. In particular, in a case where the color or the like of the external member makes the scratch formed on the coated surface noticeable, this external member may be determined as the defective product in the external appearance test step, which reduces the manufacturing efficiency of the straddle vehicle.

### SUMMARY OF THE INVENTION

The present invention addresses the above-described conditions, and an object of the present invention is to maintain the good appearance of an external member of a straddle vehicle, and increase the manufacturing efficiency of the straddle vehicle.

According to an aspect of the present invention, there is provided a straddle vehicle comprising: a first external member having an outer surface exposed to outside of the straddle vehicle, the first external member including a base section and a coating section coated on the base section, the coating section including a color layer, and a light transmission layer stacked on the color layer and having the outer surface exposed to outside of the straddle vehicle, and the light transmission layer including a self-restoring resin.

In a case where a scratch (flaw) is formed on the outer surface of the first external member of the straddle vehicle, the outer surface of the external member is naturally self-restored from the scratch to its original state, because of the elasticity of the self-restoring resin. Therefore, without carrying out a maintenance work, the external appearance of the external member which is seen by a person can be kept good, even in a state in which external light travels through the light transmission layer and is reflected on the color layer. In addition, in the course of manufacturing steps of the straddle vehicle, the outer surface of the external member is self-restored from the scratch (depression) formed on the outer surface to its original state. In this way, a rejection rate with which the external member is determined as a defective product in the external appearance test step can be reduced. As a result, a scratch repair step for the defective product can be reduced, and the manufacturing efficiency of the straddle vehicle can be improved.

According to another aspect of the present invention, there is provided an external member having an outer surface exposed to outside of a straddle vehicle, the external member comprising: a base section; and a coating section coated on the base section, the coating section including a self-restoring layer containing a self-restoring resin.

In accordance with this configuration, as in the above configuration, the external appearance of the external member of the straddle vehicle can be kept good, and the manufacturing efficiency of the straddle vehicle can be increased.

The above and further objects, features and advantages of the present invention will more fully be apparent from the following detailed description of a preferred embodiment with reference to the accompanying drawings.

### BRIEF DESCRIPTION OF THE DRAWINGS

FIG. 1 is a side view of a motorcycle according to the embodiment of the present invention.

FIG. 2 is an enlarged cross-sectional view showing the major parts of a fuel tank of the motorcycle of FIG. 1.

FIG. 3 is an enlarged cross-sectional view of the major parts of a side cowling of the motorcycle of FIG. 1.

FIG. 4 is an enlarged cross-sectional view showing major parts of a fuel tank according to a modified example.

FIG. 5 is a cross-sectional view showing major parts of a side cowling according to a modified example.

FIG. 6 is an enlarged cross-sectional view showing a light transmission later according to another modified example.

### DETAILED DESCRIPTION OF THE PREFERRED EMBODIMENTS

Hereinafter, the embodiment of the present invention will be described with reference to the drawings. The stated directions are from the perspective of a rider straddling a motorcycle.

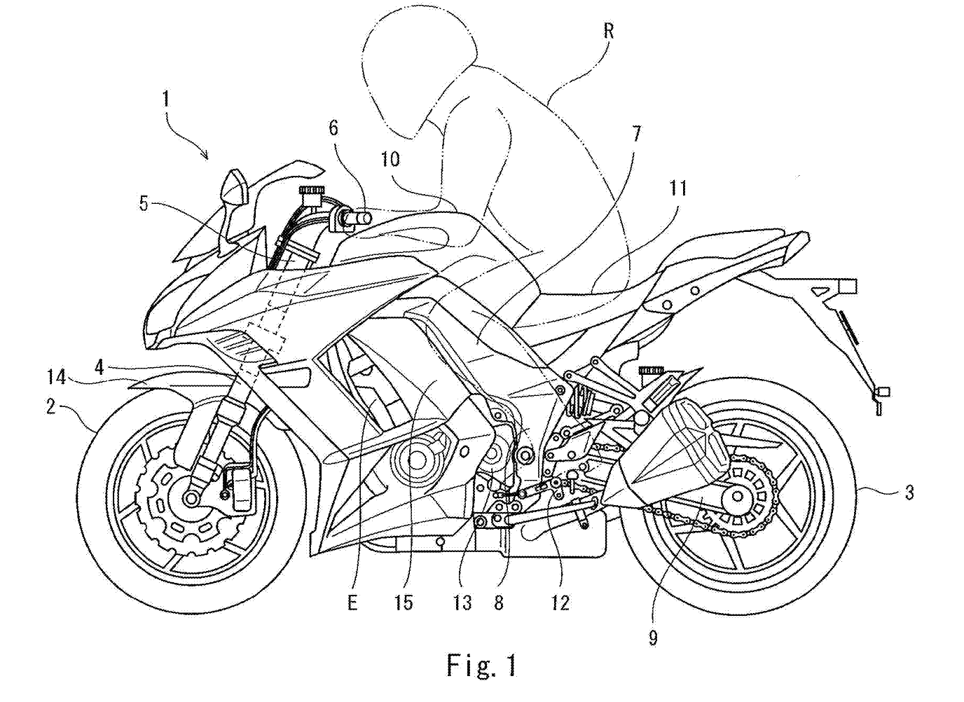

FIG. 1 is a side view of a motorcycle 1 according to the embodiment of the present invention. As shown in FIG. 1, the motorcycle 1 includes a front wheel 2 and a rear wheel 3. The front wheel 2 is connected to a front fork 4. The front fork 4 is mounted to a steering shaft (not shown) which is rotatably supported by a head pipe 5. A bar-type handle 6 which can be gripped by a rider R is attached to the steering shaft in such a manner that the handle 6 extends to the right and the left substantially in a vehicle width direction (rightward and leftward direction). To steer the motorcycle 1, the rider R steers the handle 6 to rotate the front wheel 2 via the steering shaft. A pair of right and left main frames 7 extend rearward from the head pipe 5 in such a manner that the main frames 7 are inclined in a downward direction. A pair of right and left pivot frames 8 are connected to the rear portions of the pair of main frames 7, respectively. The front end portions of a swing arm 9 are connected to the pivot frames 8 in such a manner that the swing arm 9 is pivotable. The rear wheel 3 is rotatably mounted on the rear end portion of the swing arm 9. A fuel tank 10 is placed rearward relative to the handle 6. A seat 11 which can be straddled by the rider R is placed behind the fuel tank 10.

At least a part of the fuel tank 10 is located above the main frames 7. The fuel tank 10 is located in front of the seat 11 and adjacently to the seat 11. The fuel tank 10 protrudes farther upward than the seat 11 does. The fuel tank 10 has a shape in which a center portion in a forward and rearward direction swells to the right and the left. The lower rear portion of the fuel tank 10 is recessed in an inward direction of the vehicle width direction. More specifically, the dimension of the lower rear portion of the fuel tank 10 in the vehicle width direction is smaller than the dimension of the center portion of the fuel tank 10 in the forward and rearward direction. The rider R grips a part of the fuel tank 10, to be precise, the lower rear portion of the fuel tank 10, with the inner side portions of legs, mainly, knees. Thus, in a state in which the posture of the rider R is stabilized, the rider R steers the motorcycle 1.

Foot rests 12 are provided on the rider and left sides, below the seat 11 to allow feet of the rider R to be put thereon. Between the front wheel 2 and the rear wheel 3, an engine E is placed. The engine E is mounted on the main frames 7 and the pivot frames 8. A transmission 13 is connected to the output shaft of the engine E. Driving power is transmitted from the transmission 13 to the rear wheel 3 via a chain or a belt. The front wheel 2 is covered by a fender 14 from above. The fender 14 is located in front of the handle 6.

The motorcycle 1 includes a cowling which is an outer member disposed at an outermost position of the motorcycle 1. The cowling is one of external members (components). For example, the cowling is used to guide air flowing from the front to reduce air resistance, to suppress the flow of the air toward the rider, or to cover internal members for improved design. In many cases, the cowling is colored, or is provided with textures or patterns. In the present embodiment, the cowling is one of resin members made of a resin material. The cowling may include a front cowling, side cowlings, a seat cowling, and a rear cowling.

A pair of side cowlings 15 are provided to extend from the front of the head pipe 5 to the right and left of the engine E. The fuel tank 10, the fender 14 and the side cowlings 15 are the external members (components) having outer surfaces which are exposed in the motorcycle 1. The external members have surfaces exposed as the outer surfaces of the motorcycle 1 in a state in which the external members are mounted on the vehicle body of the motorcycle 1. In the present embodiment, the plurality of external members are combined to form the outer shape of the whole of the motorcycle 1. A part of the outer surface of the fuel tank 10 is located rearward of the handle 6 and in front of the seat 11. A part of the side cowlings 15 is located rearward of the handle 6 and in front of the seat 11.

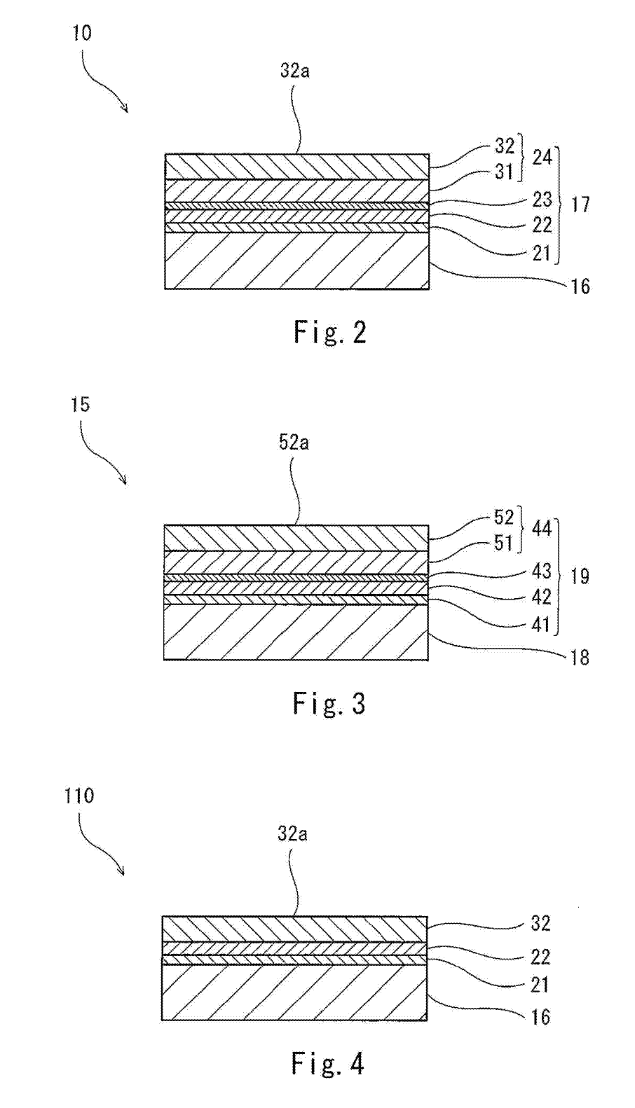

FIG. 2 is an enlarged cross-sectional view showing the major parts of the fuel tank 10 of the motorcycle 1 of FIG. 1. As shown in FIG. 2, the fuel tank 10 includes a base section 16 which is a metal container having a fuel reserving space, and a coating section 17 coated on the outer surface of the base section 16. In the present embodiment, the base section 16 is made of a metal material, more specifically a steel material having a zinc-plated (galvanized) surface. The base section 16 of the fuel tank 10 may be made of a resin (e.g., polypropylene resin, polyethylene resin, fiber-reinforced resin, etc.). The coating section 17 includes a primer layer 21, a color layer 22, a metal coating layer 23, and a light transmission layer 24, which are arranged in this order from the bottom to the top, and stacked together. The primer layer 21 is an under coating layer for preventing a rust of the base section 16 made of metal. The color layer 22 is a layer provided to have a color (tone of color) which can be seen as the outer surface of the external member. The color layer 22 contains a pigment therein to have a predetermined color. In the present embodiment, the pigment which is different from the color of the base section 15 is contained in the color layer 22. The color layer 22 allows the fuel tank 10 to have a color and secures an adhesive state between the primer layer 21 and the metal coating layer 23. In the present embodiment, for example, the color layer 22 contains a pigment with a dark color (e.g., a black color, a navy color, a blue color, etc.) having a brightness which is equal to or greater than 0% (0% or more) and less than 50%.

The metal coating layer 23 is a metal coating layer provided on the color layer 22. In the present embodiment, for example, the metal coating layer 23 is a silver mirror coating layer. Instead of the silver mirror coating layer, the metal coating layer 23 may be a plating layer comprising metal such as aluminum. The metal coating layer 23 is thinner in thickness than the color layer 22 and the light transmission layer 24 (The metal coating layer 23 has a thickness smaller than those of the color layer 22 and the light transmission layer 24). For example, the metal coating layer 23 has a thickness which is equal to or greater than 0.02 μm (0.02 μm or more), and is equal to or less than 0.1 μm (0.1 μm or less). In the present embodiment, the metal coating layer 23 has a light transmissive characteristic. Specifically, the thickness of the metal coating layer 23 is suitably adjusted so that the metal coating layer 23 functions as a half mirror. In this configuration, when the metal coating layer 23 is externally seen, the metal coating layer 23 can be seen as the external appearance of a mirror surface (mirror plane) by reflection of light, or the color of the color layer 22 can be seen as the external appearance through the metal coating layer 23, depending on an angle at which the external member is seen with respect to a light source. The metal coating layer 23 may be a layer having a color with a high light reflection rate (degree), like metallic luster.

The light transmission layer 24 disposed closer to the outermost surface of the external member contains therein a light transmissive material to allow the light transmission layer 24 to have a light transmissive characteristic. The light transmission layer 24 has a light transmissive characteristic which allows the light to be input to and reflected on at least the color layer 22. This allows the color of the color layer 22 to be seen even in the configuration in which the light transmission layer 24 is disposed closer to the outermost surface of the external member than the color layer 22. The light transmission layer 24 serves as a protective layer in some cases.

The light transmission layer 24 includes a first light transmission layer 31 as a lower layer and a second light transmission layer 32 as an upper layer, which are stacked together.

The first light transmission layer 31 is a transparent coating agent layer comprising a nonself-restoring resin (nonself-restoring layer). This nonself-restoring resin has a characteristic in which when a pencil lead with a hardness of F or more is pressed against and moved on the outer surface of a resin layer comprising the nonself-restoring resin, in a scratch hardness test (pencil method) defined in JIS standard (JIS K5600-5-4(1999)), a scratch is formed on the outer surface of the resin layer and becomes a permanent indentation, and the outer surface of the resin layer is not restored from the scratch to its original state, after a passage of time. In the present embodiment, the first light transmission layer 31 comprises a mixture of a base resin (trade name: FG clear, product number: 4207-065782, SAITO PAINT CO., LTD.), and a curing (hardening) agent (trade name: FG clear curing agent, product number: 6508-0005784, SAITO PAINT CO., LTD.). The first light transmission layer 31 is thicker than the color layer 22. Between the first light transmission layer 31 and the metal coating layer 23, a silanol group for securing an adhesive state between the first light transmission layer 31 and the metal coating layer 23 is provided.

The second light transmission layer 32 is formed of a transparent coating agent made of or including (containing) a self-restoring resin. The second light transmission layer 32 has a thickness larger than that of the color layer 22. The second light transmission layer 32 has a light transmissive characteristic. In addition, the second light transmission layer 32 serves as a self-restoring layer having a self-restoring ability (function), because of the self-restoring resin contained therein. The self-restoring resin is defined as a resin which allows a coating layer comprising the self-restoring resin to have a flexibility, namely, elastic restoration characteristic. The self-restoring layer comprising the self-restoring resin is depressed due to an external force or an impact which causes a scratch (flaw) and then is elastically restored. In a case where the self-restoring resin is used as a coating film and an external force is applied to it, it is depressed and a scratch (flaw) which is a deformation mark temporarily remains in the coating film. However, the self-restoring resin is gradually restored from the scratch (flaw) over time without conducting, for example, polishing. If the coating film is completely broken, it is not restored to its original state. For example, a coating material containing the self-restoring resin is able to have a self-restoring function by a combination of general polyisocyanate and special polyol (special component such as rotaxane or catenane) as an isocyanate curing self-restoring coating material. In a case where polyol with a low glass transition point is used, a coating film resin is softened, is easily deformed due to the external force, and exhibits the self-restoring ability. The self-restoring layer has a resin skeleton structure including a combination of a hard segment with a hard characteristic and a soft segment with an easily deformable characteristic. This allows the self-restoring layer to have an elastic restoration characteristic, like a trampoline. For example, the self-restoring resin is an acryl urethane resin. The self-restoring resin refers to a resin forming the coating layer having this self-restoring ability (elastic restoration ability). The external member including the self-restoring layer and having the self-restoring ability (function) will be referred to as a first external member. The external member which does not include the self-restoring layer and does not have the self-restoring ability will be referred to as a second external member.

An outer surface 32a of the second light transmission layer 32 (self-restoring layer) is an outer surface exposed to outside of the fuel tank 10. This self-restoring layer has a characteristic in which the outer surface of a resin layer comprising the self-restoring resin is restored from a scratch (flaw) to its original state by elastic restoration of the self-restoring resin, if the resin layer is deformed by a force externally applied and thereby the scratch is formed on the outer surface. In the present embodiment, the “scratch” means a depression (indentation) which is formed by inward deformation of the outer surface due to an external force applied thereto, and includes a depression in a state in which the restoration of the self-restoring resin does not occur yet. The outer surface having depression of the self-restoring resin which is formed by deformation due to the external force which is less than a restoration limit is elastically restored to its original shape over time. This can lessen the depression remaining (left) as the scratch.

For example, the self-restoring resin (self-restoring layer) used in the present embodiment has a characteristic in which the outer surface of the resin layer can be restored from the scratch to its original state, when 10 to 20 minutes passes after the scratch is formed, under an environment in which an ambient (atmospheric) temperature is 26 degrees C. or 30 degrees C. It is desirable that the self-restoring resin be restored to its original shape within 30 minutes, preferably 15 minutes under the ambient (atmospheric) temperature of 26 degrees C. or 30 degrees C., in a case where the external force which is less than the restoration limit is applied thereto.

The self-restoring resin (self-restoring layer) preferably has a pencil hardness of 2B or more, more preferably B or more, in the scratch hardness test (pencil method) defined in JIS standard (JIS K5600-5-4(1999)). In other words, the self-restoring resin (self-restoring layer) preferably has a hardness characteristic in which no scratch is formed on the outer surface when the outer surface of the resin layer is scratched with a pencil with a hardness of 3B and a scratch is formed on the outer surface just after the scratch hardness test, when the outer surface of the resin layer is scratched by a pencil with a hardness which is equal to or greater than 2B or B. In a case where a scratch is formed on the outer surface of the self-restoring layer just after the scratch hardness test, when the outer surface is scratched by the pencil with a specified hardness, the outer surface can be restored from the scratch to its original shape over time, because of the self-restoring function. In the present embodiment, a highest pencil hardness with which a scratch is not formed just after the scratch hardness test is assumed as a pencil hardness of the self-restoring resin. Time required to self-restore the outer surface of the self-restoring resin (self-restoring layer) with a pencil hardness of 2B from the scratch to its original state is shorter than time required to self-restore the outer surface of the self-restoring resin with a pencil hardness of B from the scratch to its original state, just after the scratch test. On the other hand, the self-restoring resin with a pencil hardness of B is polished more uniformly than the self-restoring resin with a pencil hardness of 2B is, in the step of polishing the outer surface (self-restoring resin) before shipping of the motorcycle 1.

In the case of the self-restoring resin with a pencil hardness less than B, swelling of the self-restoring resin is kept unresolved if a state in which gasoline adheres to the self-restoring resin continues, and the external appearance is degraded. In the case of the self-restoring resin with a pencil hardness of B or more, swelling of the self-restoring resin does not occur or can be resolved in a short time. To improve gasoline proofness, the self-restoring resin with a pencil hardness of B or more is preferably used. In other words, the hardness of the self-restoring layer is preferably set so that the outer surface of the self-restoring layer is not sufficiently restored and a scratch remains (is left) in the outer surface when 5 minutes passes under the condition of 23 degrees C. and the outer surface of the self-restoring layer is sufficiently restored from the scratch after a passage of 10 minutes. Or, the hardness of the self-restoring layer is preferably set so that a scratch remains (is left) in the outer surface when 1 minutes passes under the condition of 30 degrees C. and the outer surface of the self-restoring layer is sufficiently restored from the scratch after a passage of 5 minutes. In another example, the hardness of the self-restoring layer may be set so that a scratch remains when 5 minutes passes under the condition of 30 degrees C. and the outer surface of the self-restoring layer is sufficiently restored from the scratch after a passage of 10 minutes. The hardness, namely, a hardening (curing) agent ratio (weight ratio of the hardening agent to a base resin) or a hydroxyl amount of an acrylic polyol resin is increased to make a crosslinking density high to an extent that the outer surface of the self-restoring layer is not sufficiently restored within a specified time (e.g., 1 minute). This makes it possible to suitably use the self-restoring layer as the external member for the vehicle, while improving the gasoline proofness and maintaining the self-restoring ability. The hardening agent ratio is preferably higher than 0.16 (base resin: hardening agent=100: 16) to increase the crosslinking density to an extent that the gasoline proofness can be improved. The hardening agent ratio which is equal to or higher than 0.2 can increase the cross-linking density to extent that a brake fluid proofness can be improved. The hardening agent ratio is preferably equal to or higher than 0.25, and more preferably equal to or higher than 0.27. With these ratios, degradation caused by contact with the gasoline or the brake fluid can be suitably prevented.

The self-restoring resin (self-restoring layer) preferably has a pencil hardness of F or less, more preferably, HB or less, in the scratch hardness test (pencil method) defined in JIS standard (JIS K5600-5-4(1999)). In the present embodiment, the second light transmission layer 32 is a mixture of a base resin (trade name: KJY31, NATOKO CO., LTD), and a curing agent (trade name: KJY31 curing agent, NATOKO CO., LTD).

In the present embodiment, as the hardness for maintaining the restoring characteristic, the pencil hardness of HB or less is preferable in a case where the base section 16 is made of a resin, and the pencil hardness of H or less is preferable in a case where the base section 16 is made of metal. From this, a common self-restoring layer can be used irrespective of the material of the base section 16, by setting the hardness to HB or less. Also, it was observed that the self-restoring layer 32 of the present embodiment could be restored from the scratch to its original state after a passage the restoration time, in a case where the self-restoring layer 32 was scratched by a pencil with a pencil hardness of 4H in the scratch test. On the other hand, a scratch was formed and left on the nonself-restoring layer by a pencil with a pencil hardness of F in the scratch test.

In the present embodiment, in a case where the self-restoring resin is restored from the scratch to its original state in a short time, it is easy to determine whether or not a work for repairing the scratch formed on the self-restoring layer 32 in the manufacturing step is necessary. However, the hardness of the self-restoring layer 32 is preferably set so that the self-restoring layer 32 is not completely restored within a specified time after the scratch is formed, for example, within 1 minute, preferably within 3 minutes. By setting the hardness of the self-restoring layer 32 in this way, the self-restoring layer 32 can be restored well, while meeting the requirements of the external member mounted on the vehicle, for example, the hardness which allows the repairing work to be performed easily and gasoline proofness.

In the present embodiment, a force of 5N (500 gf) was exerted on a friction member with a square shape having 20 mm sides and the friction member was slid, in a state in which a cotton cloth was placed between the friction member and the outer surface of the self-restoring layer. In addition, a force of 10N (1000 gf) was exerted on a friction member with a square shape having 20 mm sides and the friction member was slid, in a state in which a leather cloth was placed between the friction member and the outer surface of the self-restoring layer. After this test, it was observed that a scratch was formed on the nonself-restoring layer with a pencil hardness of F in a state in which the self-restoring layer was not provided. In contrast, in the case of the self-restoring layer 32 of the present embodiment, no scratch was observed when at least 10 minutes passed. Thus, it was found out that the self-restoring layer 32 had a sufficient restoration characteristic.

FIG. 3 is an enlarged cross-sectional view of the major parts of the side cowling 15 of the motorcycle 1 of FIG. 1. In the present embodiment, the side cowling 15 is a resin member made of a resin material. As shown in FIG. 3, the side cowling 15 includes a base section 18 comprising a synthetic resin, and a coating section 19 coated on the outer surface of the base section 18. The coating section 19 includes an electrically-conductive primer layer 41, a color layer 42, a metal coating layer 43, and a light transmission layer 44 which are arranged in this order from the bottom to the top, and stacked together. The light transmission layer 44 includes a first light transmission layer 51 as a lower layer and a second light transmission layer 52 as an upper layer which are stacked together. The second light transmission layer 52 has a light transmissive characteristic. The second light transmission layer 52 contains the self-restoring resin and functions as the self-restoring layer having a self-restoring ability. An outer surface 52a of the second light transmission layer 52 is an outer surface exposed to outside of the side cowling 15. The electrically-conductive primer layer 41 is an under coating layer for providing an adhesive state between the base section 18 comprising the synthetic resin, and the color layer 42, and for electrostatically coating the color layer 42. The color layer 42, the metal coating layer 43, and the light transmission layer 44 of the side cowling 15 are the same as the color layer 22, the metal coating layer 23, and the light transmission layer 24 of the fuel tank 10, respectively. The first light transmission layer 51 and the second light transmission layer 52 of the side cowling 15 are the same as the first light transmission layer 31 and the second light transmission layer 32 of the fuel tank 10, respectively.

The outer surface of the external member which is placed in front of the handle 6 or rearward relative to the seat 11 may be formed of a transparent coating agent comprising the nonself-restoring resin. The outer surface of the external member in which the color layer of the coating section has a brightness that is equal to or greater than 50% (50% or more) and is equal to or less than 100% (100% or less) may be formed of a transparent coating agent comprising the nonself-restoring resin. For example, the outer surface of the fender 14 (see FIG. 1) may be formed of a transparent coating agent comprising the nonself-restoring resin. Specifically, the fender 14 may include a base section comprising a synthetic resin, and a coating section stacked on the base section, the coating section may include a color layer and a metal coating layer, and a light transmission layer stacked on the metal coating layer may comprise the nonself-restoring resin, without the self-restoring resin.

In a case where a scratch is formed on the outer surface 32a of the fuel tank 10 or the outer surface 52a of the side cowling 15 of the motorcycle 1, the outer surface 32a, 52a is naturally restored from the scratch (depression) to its original state, because of the elasticity of the self-restoring resin of the second light transmission layer 32, 52. Therefore, without carrying out a maintenance work, the external appearance of the external member which is seen by a person can be kept good, even in a state in which the external light travels through the light transmission layer 24, 44 and is reflected on the color layer 22, 42. The straddle vehicle has a relatively small size compared to a four-wheeled vehicle because the straddle vehicle is straddled by the rider. For this reason, the whole of the vehicle body is easily seen and a scratch formed on the outer surface is noticeable. In accordance with the configuration of the present embodiment, formation of a scratch can be prevented. As a result, the external appearance of the motorcycle 1 can be easily maintained.

In addition, in the course of manufacturing steps of the motorcycle 1, the outer surface 32a of the fuel tank 10 or the outer surface 52a of the side cowling 15 is self-restored from the scratch formed on the outer surface 32a, 52a to its original state. Therefore, a rejection rate with which the external member is determined as a defective product in the external appearance test step can be reduced. As a result, a work for preventing formation of a scratch can be reduced in number of times, or can be omitted, and a scratch repair step for the defective product is reduced. Thus, the manufacturing efficiency of the motorcycle 1 can be improved. Further, in some cases, a protective sheet for protecting the external member from a scratch can be omitted. Since the step of mounting the protective sheet can be omitted, the manufacturing efficiency of the motorcycle 1 can be further improved. In a case where the components and members are manually assembled into the motorcycle 1 by an operator, the present invention is very useful.

Especially, in a case where a scratch is formed in the outer surface of the external member including the metal coating layer 23, 43, the light reflected on the metal coating layer 23, 43 is scattered on a region having the scratch, and the region having the scratch glitters in a white color and is noticeable. In the present embodiment, it becomes possible to prevent such a noticeable scratch from being formed and left on the external member including the metal coating layer 23, 43. As a result, the external appearance of the motorcycle 1 can be improved.

Since the self-restoring resin (self-restoring layer) has a pencil hardness that is preferably 2B or more, more preferably, B or more, it becomes possible to prevent a situation in which the outer surface 32a, 52a is excessively soft and is polished non-uniformly, in the step for repairing and polishing the outer surface 32a of the fuel tank 10 and/or the outer surface 52a of the side cowling 15, if a scratch is detected before shipping of the motorcycle 1. In the case where the self-restoring resin has a pencil hardness of 2B or more, it becomes possible to prevent a situation in which the scratch is easily formed on the outer surface 32a, 52a, due to a minor incident in the manufacturing steps of the motorcycle 1. This eliminates a need for a work for repairing the scratch. As a result, a self-restoring ability, a polishing performance, and high work efficiency can be realized. Since the self-restoring resin has a pencil hardness that is preferably 2B or more, more preferably, B or more, the gasoline proofness can be improved. The reason is as follows. If the self-restoring resin is excessively soft (the hardness of the self-restoring is excessively low), the self-restoring resin is swollen and the coating film gets soft. In the present embodiment, since the self-restoring resin (self-restoring layer) has a pencil hardness that is preferably 2B or more, more preferably, B or more, the external member of the straddle vehicle which travels using gasoline as fuel can have high durability.

Since the self-restoring resin has a pencil hardness that is preferably F or less, more preferably, HB or less, it becomes possible to prevent a situation in which a long time passes from when the scratch is formed on the outer surface 32a, 52a until the outer surface 32a, 52a is self-restored from the scratch to its original state. Thus, it is highly probable that self-restoration of the outer surface 32a, 52a from the scratch formed in the manufacturing steps of the motorcycle 1 is completed before the external test step starts. Therefore, the rejection rate with which the external member is determined as the defective product in the external appearance test step can be further reduced, and the manufacturing efficiency of the motorcycle 1 can be further increased.

The straddle vehicle is steered by the rider straddling the external member constituting the outer surface of the vehicle. For this reason, the rider contacts the outer surface of the external member more frequently compared to a four-wheeled vehicle during traveling. More specifically, the rider steers the vehicle while gripping the vehicle body with knees, and the clothes of the rider's legs contact the side surfaces of the vehicle body. In a case where the posture of the rider is shifted to tilt the vehicle body during a turn, the clothes may rub the side surface of the vehicle body. Likewise, in a case where the weighted center of the rider is shifted vertically or the rider is getting off the vehicle, the clothes sometimes rub the side surface of the vehicle body. In a case where the rider is inclined to the front, to reduce air resistance during traveling, the clothes of the rider's chest may contact or rub the outer surface of the fuel tank. For example, portions of the side surfaces of the vehicle body which contact the clothes of the leg are located in front of a seat and below the upper surface of the seat. More specifically, the portions which the clothes rub may be the side cowlings corresponding to the side surfaces of the vehicle body which are located below the fuel tank, the side portions of the fuel tank which are located in front of the seat, or a tank cover covering the side surfaces of the fuel tank. In the above-described configuration, since each of the outer surfaces 32a, 52a of the fuel tank 10 and the side cowling 15 which are placed in front of the seat 11 straddled by the rider R and rearward relative to the handle 6 gripped by the rider R has the self-restoring characteristic, the external appearance of the external member on which the scratch may be formed due to a friction with the rider's clothes or the like, can be kept good, while the rider R is riding on the motorcycle 1. In addition, since portions of the side cowlings which are rearward of the rider seat are provided with the self-restoring resin layers, it becomes possible to suppress a scratch caused by contact between the clothes of a passenger and the outer surface of the external member, or a scratch caused by dismounting stuff (belongings). Thus, the portions which the clothes rub may be the portions of the cowlings which are located below a passenger seat.

In a case where the color layer 22, 42 is seen as the external appearance, a region having a scratch is noticeable in comparison with the color layer 22, 42.

Since each of color layer 22 of the fuel tank 10 and the color layer 42 of the side cowling 15 has the dark color with a brightness which is equal to or greater than 0% (0% or more) and less than 50%, and the scratch formed on the outer surface 32a, 52a looks white and is noticeable compared to a region which looks dark due to the color layer 22, 42. However, in accordance with the configuration of the present embodiment, the outer surface 32a, 52a is self-restored from the scratch to its original state, because of the elasticity of the self-restoring resin. Therefore, the configuration of the present embodiment has an advantage in that the external appearance of the external member can be kept good, and the manufacturing efficiency of the motorcycle 1 can be increased.

The external members covering the engine E as a heat generating source from above and from the side, for example, the fuel tank 10 and the side cowling 15 are provided with the self-restoring resin. Therefore, the external members are warmed by heated air radiated from the engine E. This allows the self-restoring resin to increase the restoring ability.

Since the first light transmission layer 31, 51 comprises the nonself-restoring resin, and the second light transmission layer 32, 52 comprises the self-restoring resin, the self-restoring resin can be used only in the second light transmission layer 32, 52, while sufficiently absorbing ultraviolet rays of incident light and reflected light by use of the first light transmission layer 31, 52 and the second light transmission layer 32, 52. As a result, the amount of usage of the self-restoring resin can be reduced, while increasing the ability to absorb the ultraviolet rays.

As described above, the external member which the rider's clothes are likely to contact during traveling is referred to as the first external member including the self-restoring resin, while the external member which the clothes are less likely to contact during traveling, for example, the fender or the front cowling, is referred to as the second external member which includes the nonself-restoring resin and does not include the self-restoring resin. This makes it possible to reduce the members provided with a self-restoring coating to reduce cost, compared to a case where all of the external members of the vehicle body include the self-restoring resin, and to prevent a scratch caused by contact between the clothes and the external member. Since the self-restoring resin is used for only the portions on which a scratch is likely to be formed, as well as the portions which the clothes contact during traveling, formation of a scratch can be effectively prevented.

In addition to the portions which the clothes contact, the self-restoring resin may be used for the external member including a region surrounding a location where a key is inserted because a scratch is likely to be formed in this region. Even in a case where the key contacts a region which is in the vicinity of an insertion hole when the key is inserted into the insertion hole, formation of a scratch in this region can be prevented, and the external appearance of the motorcycle 1 can be easily maintained. Further, the self-restoring resin may be used for the external member including a location where a fastening member such as a bolt is inserted to mount and dismount the external member or an internal member, or the external member including a region surrounding a location where a tool is inserted to adjust the internal member.

In an alternative example, glittering particles may be dispersed in a region between the metal coating layer 23, 43 and the light transmission layer 24, 44 of the fuel tank 10 or the side cowling 15. For example, aluminum flakes (small pieces of an aluminum foil), scale-like pieces of a glass, pearl pieces (mica pieces), or a combination of these may be used, as the glittering particles. In this case, the scratch formed on the outer surface of the fuel tank 10 or the side cowling 15 is easily noted due to the light reflected on the glittering particles. However, in accordance with the configuration of the present embodiment, the second light transmission layer 32, 52 is naturally self-restored from the scratch to its original state, because of its elasticity of the self-restoring resin. Therefore, the configuration of the present embodiment has an advantage in that the external appearance of the external member can be kept good and the manufacturing efficiency of the motorcycle 1 can be increased.

FIG. 4 is an enlarged cross-sectional view showing major parts of a fuel tank 110 according to a modified example. As shown in FIG. 4, the fuel tank 110 includes the color layer 22 and the light transmission layer 32 directly stacked on the color layer 22. In other words, in the fuel tank 110, the metal coating layer 23 and the first light transmission layer 31 including the nonself-restoring resin are omitted. Also, in this configuration, the external appearance of the external member (the fuel tank 110) can be kept good, and manufacturing efficiency can be increased. Even in a case where the metal coating layer 23 is not provided, the light transmission layer 32 including the self-restoring resin is restored from a scratch to its original state. This can make a scratch region less noticeable with respect the color layer 22. In a case where the color layer 22 has a black color or a color which is close to black, this effect is significant. Even in a case where the color layer has a white color or a color which is close to white, the effect of making the scratch less noticeable can be obtained.

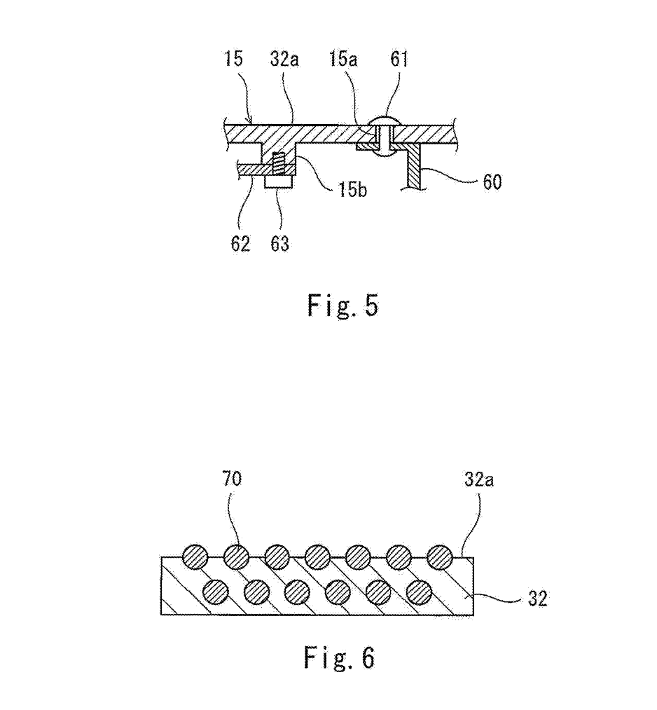

FIG. 5 is a cross-sectional view showing major parts of the side cowling 15 according to a modified example. As shown in FIG. 5, on an inner side of the side cowling 15 mounted on the vehicle body, members 60, 62 to be mounted (mounted members 60, 62) on the side cowling 15, such as a support member or a coolant tank, are placed. The mounted members 60, 62 are supported by the side cowling 15 in a state in which the side cowling 15 is mounted on the vehicle body. In other words, at least a part of the mounted members 60, 62 are covered by the side cowling 15, and a portion exposed outside the vehicle body can be reduced. The mounted members may include a support member used to support another mounted member such as a support member (bracket) by the side cowling 15. In particular, a sub-unit with the mounted member mounted on the side cowling 15 is fastened to a vehicle body frame or a stay supported by the vehicle body frame.

The side cowling 15 is formed with a mounting hole 15a and a mounting seat 15b as a mounting section. The mounted member 60 is mounted on the side cowling 15 by use of a fastening member 61 (e.g., rivet) inserted into the mounting hole 15a. The mounted member 62 is mounted on the mounting seat 15b of the side cowling 15 by use of a fastening member such as a bolt or a screw. In this configuration, in the step of forming the sub-unit of the side cowling 15, the mounted members are mounted on the side cowling 15 in a state in which the outer surface of the side cowling 15 is held. In this case, a tool, the member, or the like contact (rub) the outer surface of the side cowling 15, and a scratch is likely to be formed on the outer surface of the side cowling 15. However, the outer surface of the side cowling 15 including the self-restoring resin can be restored from the scratch to its original state.

FIG. 6 is an enlarged cross-sectional view showing the light transmission layer 32 according to another modified example. As shown in FIG. 6, the outer surface 32a of the light transmission layer 32 including the self-restoring resin has a concave-convex shape (includes concave-convex portions). For example, the light transmission layer 32 contains delustering particles 70 as a delustering agent (delustrant) in at least the outer surface 32a to form the concave-convex shape in the outer surface 32a. The delustering particles 70 are used to form the concave-convex shape on the outer surface of the external member. The delustering particles 70 are contained in paint forming the outermost surface of the external member. Parts of the delustering particles 70 protrude from the outer surface of the external member and form the concave/convex portions in the outer surface of the external appearance so that luster of the outer surface 32a is suppressed by utilizing scattered (diffused) reflection. For example, as the delustering particles 70, particles of silica or the like are used. The metal coating layer may or may not be provided under the light transmission layer 32.

For example, in a case where the clothes of the rider R rub the outer surface 32a of the light transmission layer 32 and thereby an external force is applied to the convex portions (particles 70) provided in the self-restoring resin, this external force is absorbed by elasticity of the light transmission layer 32 as the self-restoring resin. This makes it possible to prevent a situation in which the convex portions (particles 70) are disengaged from the light transmission layer 32 or buried in the light transmission layer 32. By using the self-restoring resin in the outermost surface of the external member provided with the delustering agent, a delustering effect can be maintained for a long period of time, and the external appearance of the external member can be kept well.

Numerous improvements and alternative embodiment of the invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the scope of the invention. For example, the outer surface 32a of the light transmission layer 32 may be provided with another functional layer, specifically, a water-repellent hardening (curing) layer (e.g., glass coating). In a case where a sticker is placed on a portion of the external member on which the self-restoring resin is coated, the outer surface of the sticker and the outer surface of the external member may be collectively coated with the self-restoring resin. Or, the outer surface of the sticker may be coated with the self-restoring resin. Suitably, the self-restoring resin forming the light transmission layer does not contain a water-repellent group, because overcoating of the self-restoring resin is possible.

The metal coating layer may not have a light transmissive characteristic. In other words, the metal coating layer with a thickness for allowing the metal coating layer to become a full mirror may be provided. In this case, also, since it is possible to prevent a situation in which a region having a scratch is noticeable due to the fact that the light reflected on the metal coating layer is scattered in the region having the scratch.

Although the self-restoring resin is used for the portions of the vehicle body which the clothes of the rider or the passenger contact (rub), the self-restoring resin may be used for another portion. For example, the self-restoring resin may be coated over the whole of the portions forming the external appearance. Specifically, the self-restoring resin may be used for the cowlings such as the front cowling, which are other than the side cowlings 15.

The present invention is applicable to a case where the metal coating layer includes the glittering particles to form a metallic appearance, or a case where the outer surface 32a of the light transmission layer 32 includes the delustering agent to form a delustering (mat) appearance, as described above. Although in the present embodiment, the outer surface 32a of the light transmission layer 32 has a pearskin shape for delustering in which the concave-convex portions are formed on the outer surface 32a by use of the delustering agent, the present invention is applicable in the same manner to a case where the pearskin shape is formed, by devising a coating method. Also, in a case where concave-convex portions are formed for a purpose different from the delustering, the concave-convex portions can be kept, and the function of the concave-convex portions can be easily maintained.

In an alternative example, in a case where the base section is colored, like a resin material containing a pigment, the color layer may be omitted. Further, the color layer may include a self-restoring paint. In other words, in a case where the color layer serves as the self-restoring layer, the light transmission layer may be omitted. Further, the light transmission layer including the self-restoring resin may be provided on the outer surface of a frame as the external member. For example, in a case where knee grip portions which are gripped with the rider's knees, are located in front of the rider seat, and have a dimension in a vehicle width direction smaller than that of the remaining portions in a forward and rearward direction include frame members, each of the knee grip portions of the frame members may be provided with the color layer and the light-transmission layer including the self-restoring resin disposed on the color layer.

The external member which is placed in front of the seat and rearward relative to the handle, and protrudes farther upward than the seat does may be a fuel tank cover. In a case where the motorcycle is an electric vehicle which does not include an internal combustion engine, the external member which is placed in front of the rider seat and rearward relative to the handle, and protrudes farther upward than the rider seat does may be a dummy tank or a tank cover instead of the fuel tank. Further, although the motorcycle is exemplarily described as the straddle vehicle, the straddle vehicle may be, for example, an all terrain vehicle (ATV) or personal watercraft (PWC), so long as the straddle vehicle is a vehicle steered by the rider straddling the seat.

1. A straddle vehicle comprising:
a first external member having an outer surface exposed to outside of the straddle vehicle,
the first external member including a base section and a coating section coated on the base section,
the coating section including a color layer, and a light transmission layer stacked on the color layer and having the outer surface exposed to outside of the straddle vehicle, and
the light transmission layer including a self-restoring resin.

2. The straddle vehicle according to claim 1,
wherein the self-restoring resin has a pencil hardness that is equal to or greater than 2B.

3. The straddle vehicle according to claim 1,
wherein the self-restoring resin has a pencil hardness that is equal to or less than F.

4. The straddle vehicle according to claim 1,
wherein the first external member includes a region that is located in front of a seat straddled by a rider and rearward of a handle gripped by the rider.

5. The straddle vehicle according to claim 1,
wherein the color layer has a dark color with a brightness that is equal to or greater than 0% and less than 50%.

6. The straddle vehicle according to claim 1,
wherein the coating section further includes a metal coating layer disposed between the color layer and the light transmission layer.

7. The straddle vehicle according to claim 1,
wherein the first external member is a member disposed at a portion of a vehicle body which clothes of a rider or passenger riding in the straddle vehicle contact.

8. The straddle vehicle according to claim 1,
wherein the first external member is a fuel tank.

9. The straddle vehicle according to claim 1,
wherein the first external member is a resin member including a resin material.

10. The straddle vehicle according to claim 1,
wherein the first external member is a cowling which clothes of a rider or passenger riding in the straddle vehicle contact.

11. The straddle vehicle according to claim 9,
wherein the first external member is provided with a mounting section used to mount a mounted member on the first external member, from an inner side of the first external member.

12. The straddle vehicle according to claim 1,
wherein an outer surface of the light transmission layer has a concave-convex shape.

13. The straddle vehicle according to claim 12,
wherein the light transmission layer is provided with delustering particles in at least the outer surface thereof.

14. The straddle vehicle according to claim 1, further comprising:
a second external member having an outer surface exposed outside the straddle vehicle,
wherein the second external member includes a base section and a coating section coated on the base section,
wherein the coating section includes a color layer, and a light transmission layer stacked on the color layer and having the outer surface, and
wherein the light transmission layer of the second external member includes a nonself-restoring resin.

15. An external member having an outer surface exposed to outside of a straddle vehicle, the external member comprising:
a base section; and
a coating section coated on the base section,
the coating section including a self-restoring layer containing a self-restoring resin.

16. The external member according to claim 15,
wherein an outer surface of the self-restoring layer has a concave-convex shape.

17. The external member according to claim 15,
wherein the coating section further includes a metal coating layer disposed between the base section and the self-restoring layer.

18. The external member according to claim 15,
wherein the first external member is a member which clothes of a rider or passenger riding in the straddle vehicle contact.
